(19) United States
(12) Patent Application Publication
(10) Pub. No.: US 2019/0035280 A1
(43) Pub. Date: Jan. 31, 2019

(54) LANE CHANGE SUPPORT METHOD AND APPARATUS

(71) Applicant: SAMSUNG SDS CO., LTD., Seoul (KR)

(72) Inventors: Sun Jin KIM, Seoul (KR); Du Won PARK, Seoul (KR); Ki Sang KWON, Seoul (KR); Min Kyu KIM, Seoul (KR)

(73) Assignee: SAMSUNG SDS CO., LTD., Seoul (KR)

(21) Appl. No.: 16/016,308

(22) Filed: Jun. 22, 2018

(30) Foreign Application Priority Data
Jul. 27, 2017 (KR) 10-2017-0095215

(51) Int. Cl. G08G 1/16; G06K 9/00

(52) U.S. Cl. CPC G08G 1/167; G06K 9/00798; G06K 9/00805

(57) ABSTRACT

Provided is a method of lane change support. The method comprises step of detecting lane lines by analyzing an image obtained by a first image sensor provided on a side of a vehicle and step of setting a vehicle detection region for detecting a moving object in the image obtained by the first image sensor based on the detected lane lines and step of detecting the moving object in the set vehicle detection region and judging a possibility of collision between the vehicle and the detected object and step of providing lane change information indicating whether it is dangerous for the vehicle to change lanes based on the result of judging the possibility of collision.

This application claims the benefit of Korean Patent Application No. 10-2017-0095215, filed on Jul. 27, 2017, in the Korean Intellectual Property Office, the disclosure of which is incorporated herein by reference in its entirety.

### BACKGROUND

### 1. Field

The present disclosure relates to a lane change support method and apparatus, and more particularly, to a lane change support method and apparatus employed to detect lane lines and vehicle detection regions by analyzing an image captured by an image sensor unit, detect a vehicle in a vehicle detection region, analyze the possibility of collision, and provide lane change information to a driver.

### 2. Description of the Related Art

In a conventional lane change support method, various sensors such as an ultrasonic sensor attached to a vehicle sense a collision risk with an adjacent vehicle. The sensors transmit sensed information to the driver of the vehicle, and the driver prepares for the risk of an accident using the information.

Due to the distance sensing constraints of the sensors, however, the conventional lane change support method can be used to detect a collision risk only when an adjacent vehicle is located very close to the vehicle or travelling in an adjacent lane side by side with the vehicle. Therefore, the conventional lane change support method substantially has limitations in predicting a collision itself.

In a conventional lane change support method and apparatus, it is only possible to detect an object located close to a vehicle using an ultrasonic sensor or through image analysis and inform the driver of the vehicle about the detected object. However, it is impossible to judge the possibility of collision in various lane change situations on a multi-lane road. The various lane change situations may be when a vehicle traveling in a first lane and another vehicle traveling in a third lane attempt to change to a second lane at the same time and when the first vehicle and the second vehicle traveling in the same lane attempt to change to the same lane. Therefore, there is a need for a lane change support method and apparatus capable of predicting various lane change situations.

### SUMMARY

Aspects of the present disclosure provide a lane change support method and apparatus which are employed to accurately set a vehicle detection region based on lane lines detected in an image of an area on sides of and behind a driving vehicle.

Aspects of the present disclosure also provide a lane change support method and apparatus which are employed to determine the types of the detected lane lines and issue a lane change related warning to a driver in consideration of the types of the detected lane lines.

Aspects of the present disclosure also provide a lane change support method and apparatus which are employed to detect and analyze an object in the set vehicle detection region, judge the possibility of collision between the vehicle and another vehicle located in an area other than a lane line close to the vehicle, and inform the possibility of collision.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided a method providing a lane change support, the method comprising step of detecting lane lines by analyzing an image obtained by a first image sensor provided on a side of a vehicle and step of setting a vehicle detection region for detecting a moving object in the image obtained by the first image sensor based on the detected lane lines and step of detecting the moving object in the set vehicle detection region and judging a possibility of collision between the vehicle and the detected object and step of providing lane change information indicating whether it is dangerous for the vehicle to change lanes based on the result of judging the possibility of collision.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a lane change support apparatus according to an embodiment;

FIG. 2 is a flowchart illustrating a lane change support method according to an embodiment;

FIG. 3 is a flowchart illustrating a lane change support method according to an embodiment;

FIGS. 4 and 5 are flowcharts illustrating a lane change support method according to an embodiment;

FIGS. 6A through 6C are diagrams for explaining lane line detection and determination in a lane change support method according to an embodiment;

FIGS. 7A through 7C are diagrams for explaining examples of a lane change prohibited region in a lane change support method according to an embodiment;

FIGS. 8A through 8E are diagrams for explaining vehicle detection region setting in a lane change support method according to an embodiment;

FIGS. 9A through 9D are diagrams for explaining collision possibility determination in a lane change support method according to an embodiment; and

FIGS. 10A through 10D are diagrams for explaining examples of collision avoidance determination in a lane change support method according to an embodiment.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”. “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, embodiments of the present disclosure will be described in detail with reference to the accompanying drawings.

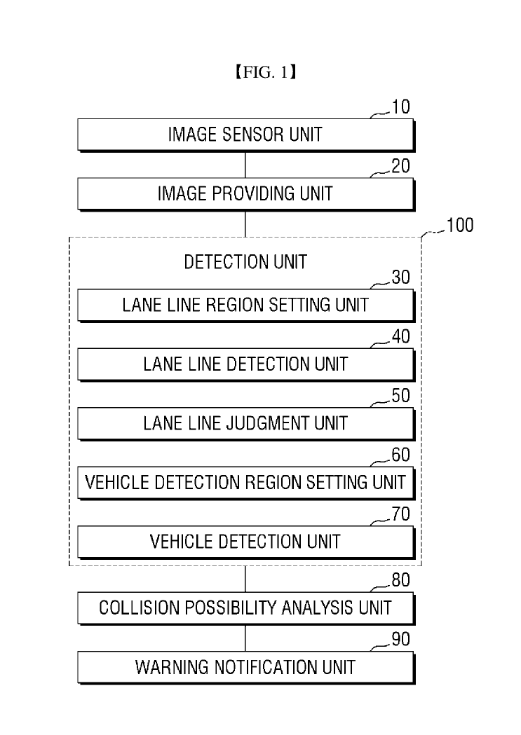

FIG. 1 is a block diagram of a lane change support apparatus according to an embodiment. The configuration of the lane change support apparatus according to the current embodiment will now be described with reference to FIG. 1.

The lane change support apparatus according to the current embodiment includes an image sensor unit 10, an image providing unit 20, a detection unit 100, a collision possibility analysis unit 80, and a warning notification unit 90. The detection unit 100 includes a lane line region setting unit 30, a lane line detection unit 40, a lane line judgment unit 50, a vehicle detection region setting unit 60, and a vehicle detection unit 70.

The image sensor unit 10 obtains an image of an area around a vehicle. The image sensor unit 10 may include at least one of a first image sensor provided on the side of the vehicle and a second image sensor provided on the rear of the vehicle. The first image sensor obtains an image used to detect lane lines located on a side of the vehicle and to set a vehicle detection region for detecting a moving object. The second image sensor obtains an image used to detect lane lines located behind the vehicle and to set a vehicle detection region for detecting a moving object.

The image providing unit 20 provides the obtained image to the detection unit 100. According to an embodiment, the image providing unit 20 may provide an image obtained by the first image sensor on the side of the vehicle to the detection unit 100.

According to an embodiment, the image providing unit 20 may correct an image obtained by the first image sensor on the side of the vehicle and an image obtained by the second image sensor on the rear of the vehicle, merge the corrected images into one image, and provide the one image to the detection unit 100. In the one image, one vehicle detection region may be shared in the same lane. If the images obtained by the first image sensor and the second image sensor are merged, a vehicle detection region may be extended backward.

When the obtained image is provided to the detection unit 100, the detection unit 100 analyzes the obtained image. The lane line region setting unit 30 detects lane lines using a lane line region candidate group set according to a standard road lane line width. By using the lane line region candidate group, it is possible to detect all lane lines at a time in the obtained image. Thus, quick lane line detection is possible. The lane line detection unit 40 detects the number and positions of lane lines, and the lane line judgment unit 50 determines whether the detected lane lines are dotted lines or solid lines. A vehicle detection region may be set based on the detected lane lines. The vehicle detection region corresponds to a region of interest (ROI) for detecting a vehicle. The vehicle detection unit 70 may detect a moving object within the vehicle detection region or a fixed object within the vehicle detection region. When analyzing an image within the vehicle detection region, the vehicle detection unit 70 may utilize various widely known object recognition techniques. The detected object may be a vehicle, an obstacle, etc. which can be located on the road.

The collision possibility analysis unit 80 judges the possibility of collision by analyzing the movement of the detected object in the vehicle detection region. If the object is another driving vehicle, a motion vector of the object indicates the relative speed between the vehicle and the another driving vehicle. Therefore, the collision possibility analysis unit 80 may judge the possibility of collision based on the motion vector of the object. In addition, the collision possibility analysis unit 80 may judge the possibility of collision by analyzing the size of the object. To judge the possibility of collision, an ultrasonic sensor provided in the vehicle can be used in addition to the obtained image.

If the collision possibility analysis unit 80 judges the possibility of collision, the warning notification unit 90 provides current lane information and lane change information to the driver of the vehicle using a notification medium provided in the vehicle. The lane change information is information indicating whether it is dangerous for the vehicle to change lanes. The lane change information may include at least one of lane change warning notification and lane change permission notification.

In the current embodiment, the configuration of the lane change support apparatus has been described. A lane change support method according to an embodiment will now be described. The description of the lane change support apparatus can be supplemented in more detail by the following description of the lane change support method.

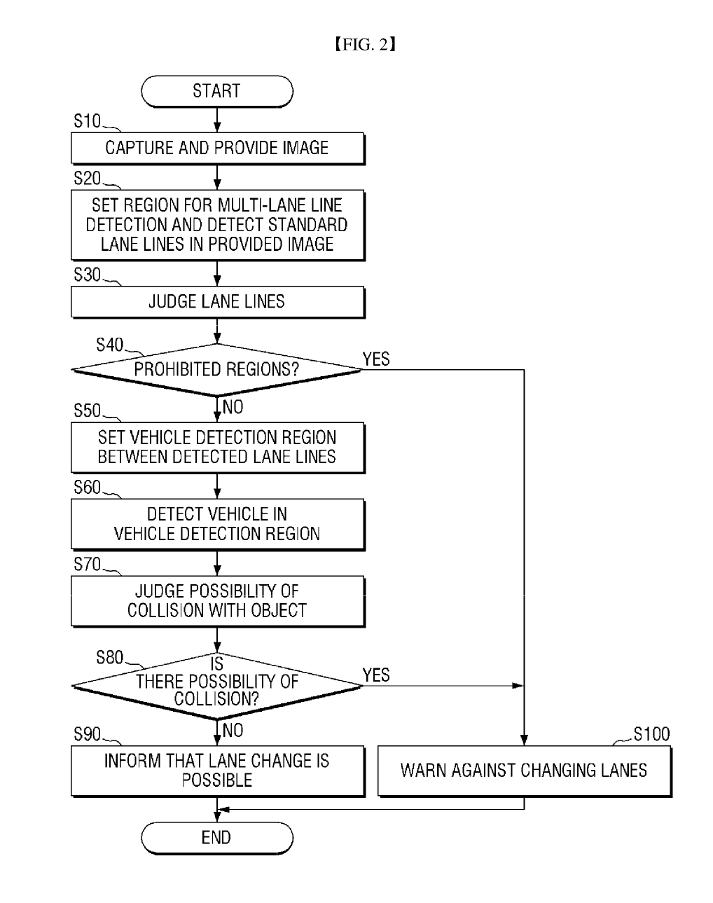

FIG. 2 is a flowchart illustrating a lane change support method according to an embodiment. The lane change support method described with reference to FIG. 2 can be understood as being performed by a specific apparatus including a computing unit such as a processor. For example, the specific apparatus may be the lane change support apparatus described above with reference to FIG. 1. Each operation included in the lane change support method according to the current embodiment will now be described. If the subject of each operation is omitted, it can be understood that the subject of the operation is the specific apparatus. The lane change support method will be described in detail with reference to FIG. 2.

An image of an area on sides of and behind a vehicle is received (operation S10). The received image is analyzed to set a region for multi-lane line detection in the received image and to detect lane lines in the received image (operation S20). To decide lane lines for setting a vehicle detection region, lane lines may be detected by analyzing the received image. In addition, lane lines may be detected by matching lane lines in the received image with lane lines in a preset region for multi-lane line detection. The region for multi-lane line detection corresponds to a lane line region candidate group set according to the standard road lane width. Next, it is determined whether the detected lane lines are dotted lines or solid lines (operation S30). If the detected lane lines are solid lines, they are lane lines where lane changing is not permitted. After the determining of whether the detected lane lines are dotted lines or solid lines (operation S30), it is determined whether the detected lane lines are lane change prohibited regions (operation S40). The prohibited regions refer to a case where the detected lane lines are determined to be solid lines. If the detected lane lines are determined to be solid lines, they are regions where lane changing is prohibited, such as a road in a tunnel, an overpass, etc. If the detected lane lines are determined to be dotted lines, they correspond to regions where lane changing is possible. Therefore, the detected lane lines are not determined to be prohibited regions.

If the detected lane lines are determined to be prohibited regions, a warning notification unit warns against changing lanes (operation S100).

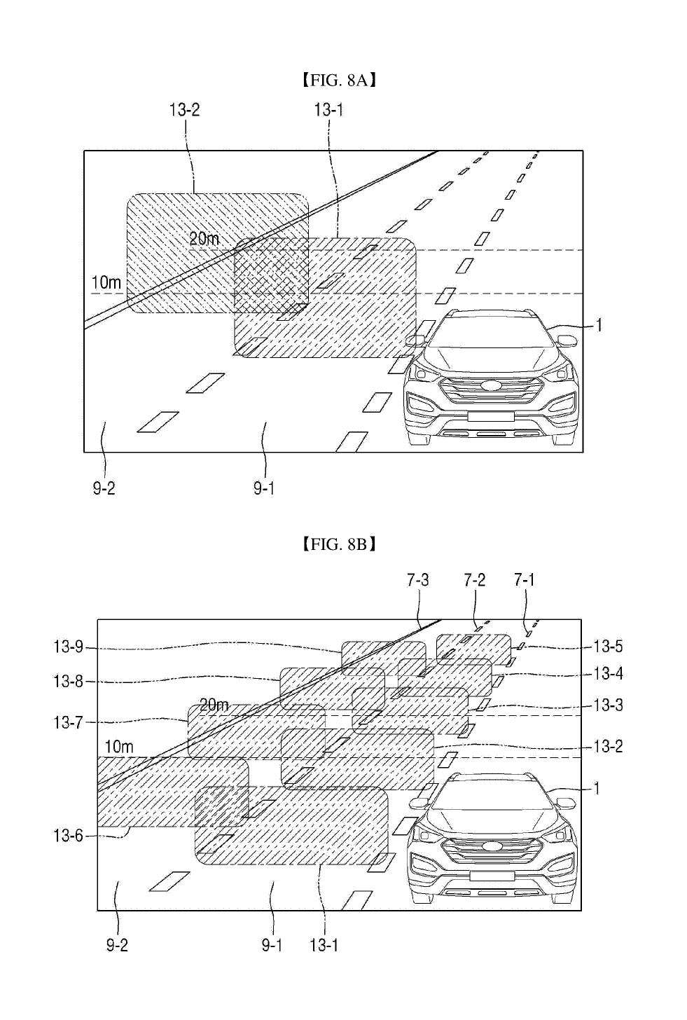

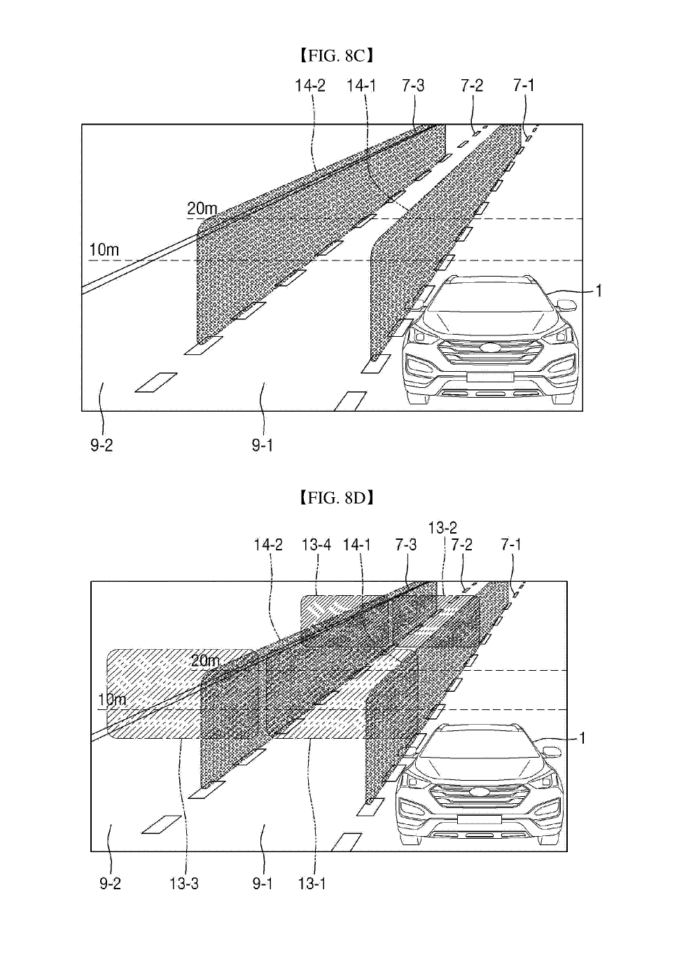

If the detected lane lines are not determined to be prohibited regions, a vehicle detection region is set based on the detected lane lines (operation S50). Two or more vehicle detection regions may be set in order to analyze the possibility of collision between the vehicle and another vehicle travelling in another lane in the same direction as the vehicle. Next, an object is detected in the vehicle detection region (operation S60), and the possibility of collision between the detected object and the vehicle is analyzed to judge the possibility of collision (operation S70). Examples of judging the possibility of collision will be described in detail later with reference to FIGS. 8A through 8E.

If it is determined that there is no possibility of collision, the driver of the vehicle is informed that a lane change is possible (operation S90). If it is determined that there is a possibility of collision, the driver of the vehicle is warned against changing lanes (operation S100).

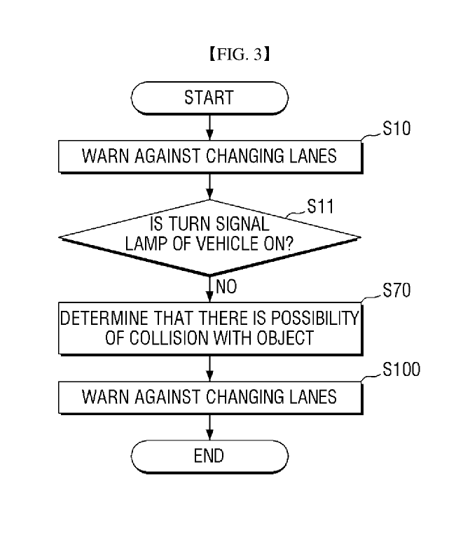

FIGS. 3 through 5 are flowcharts illustrating lane change support methods according to embodiments, depending on whether a turn signal lamp of a vehicle is used.

FIG. 3 is a flowchart illustrating a lane change support method according to an embodiment. FIG. 3 is a flowchart illustrating a lane change support method used when a turn signal lamp is not turned on. The lane change support method according to the current embodiment will now be described with reference to FIG. 3.

An image of an area on sides of and behind a vehicle is captured and obtained by an image sensor unit, and the obtained image is provided to a detection unit by an image providing unit (operation S10). Then, it is determined whether the turn signal lamp of the vehicle is on (operation S11). If the turn signal lamp of the vehicle is not on, the detection unit and a collision possibility analysis unit determines that there is a possibility of collision (operation S70) and warn against changing lanes (operation S100).

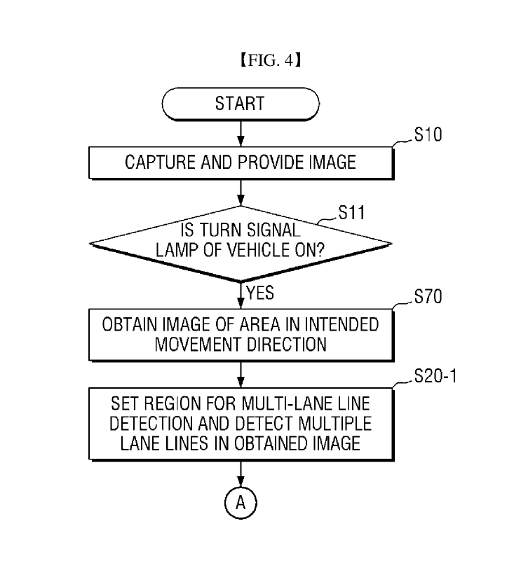

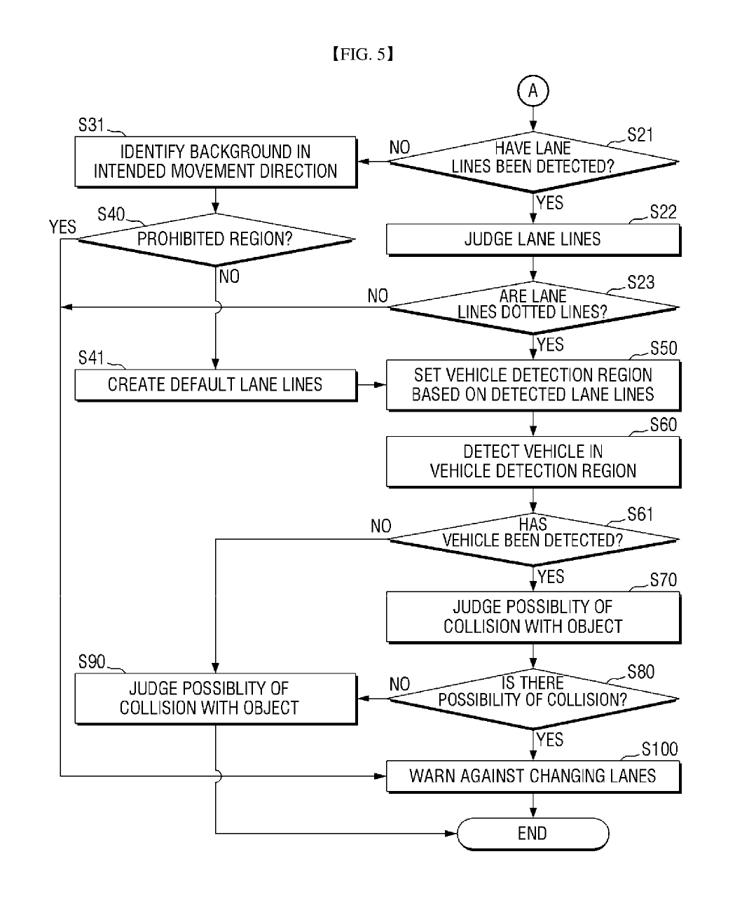

FIGS. 4 and 5 are flowcharts illustrating a lane change support method according to an embodiment. FIGS. 4 and 5 are flowcharts illustrating a lane change support method used when the turn signal lamp is turned on. The lane change support method according to the current embodiment will now be described with reference to FIGS. 4 and 5.

An image of an area on sides of and behind a vehicle is captured and obtained by the image sensor unit, and the obtained image is provided to the detection unit by the image providing unit (operation S10). Then, it is determined whether the turn signal lamp of the vehicle is on (operation S11). If the turn signal lamp of the vehicle is on, an image of an area in a direction in which the vehicle intends to move is obtained using an image sensor provided on a side of the vehicle in the intended movement direction (operation S70). When the image of the area in the intended movement direction is obtained, a region for multi-lane line detection is set in the obtained image, and multiple lane lines are detected in the obtained image (operation S20-1). The lane lines may be immediately detected in the obtained image or may be detected at the same time as the setting of the region for multi-lane line detection. The region for multi-lane line detection may correspond to a lane line region candidate group set according to the standard road lane line width.

When the lane lines are detected (operation S21), the types of the lane lines are judged (operation S22).

If the lane lines are dotted lines (operation S23), a lane change is possible. Therefore, a vehicle detection region is set based on the detected lane lines (operation S50). Two or more vehicle detection regions may be set in order to analyze the possibility of collision between the vehicle and another vehicle travelling in another lane. Next, a vehicle is detected in the vehicle detection region (operation S60). When a vehicle is detected in the vehicle detection region (operation S61), the possibility of collision with the detected vehicle is judged by sensing the movement of the detected vehicle in the vehicle detection region (operation S70). If there is a possibility of collision between the vehicle and the detected vehicle (operation S80), the driver of the vehicle is warned against changing lanes (operation S100). If there is no possibility of collision (operation S80), the driver of the vehicle is informed that a lane change is possible (operation S90).

If the lane lines are not dotted lines (operation S23), a lane change is not possible. In this case, the driver of the vehicle is warned against changing lanes (operation S100).

If no lane is detected (operation S21), the background photographed in the intended movement direction in which the turn signal lamp of the vehicle is turned on is identified (operation S31). The background in the intended movement direction is identified and analyzed to determine whether the background is a prohibited region (operation S40).

If it is determined that the background in the intended movement direction is a prohibited region, the driver of the vehicle is warned against changing lanes (operation S100). The prohibited region refers to a solid lane line in the intended movement direction or an obstacle such as a median strip.

If it is determined that the background in the intended movement direction is not a prohibited region, default lane lines are created (operation S41). The default lane lines are virtual lane lines set according to the standard road lane line width when there is no lane line in an image. A vehicle detection region is set based on the created default lane lines (operation S50). Then, a vehicle is detected in the vehicle detection region (operation S60). When a vehicle is detected in the vehicle detection region (operation S61), the possibility of collision with the detected vehicle is analyzed and judged (operation S70). If there is a possibility of collision between the vehicle and the detected vehicle (operation S80), the driver of the vehicle is warned against changing lanes (operation S100).

The lane change support method is terminated by informing that a lane change is possible (operation S90) or dangerous (operation S100).

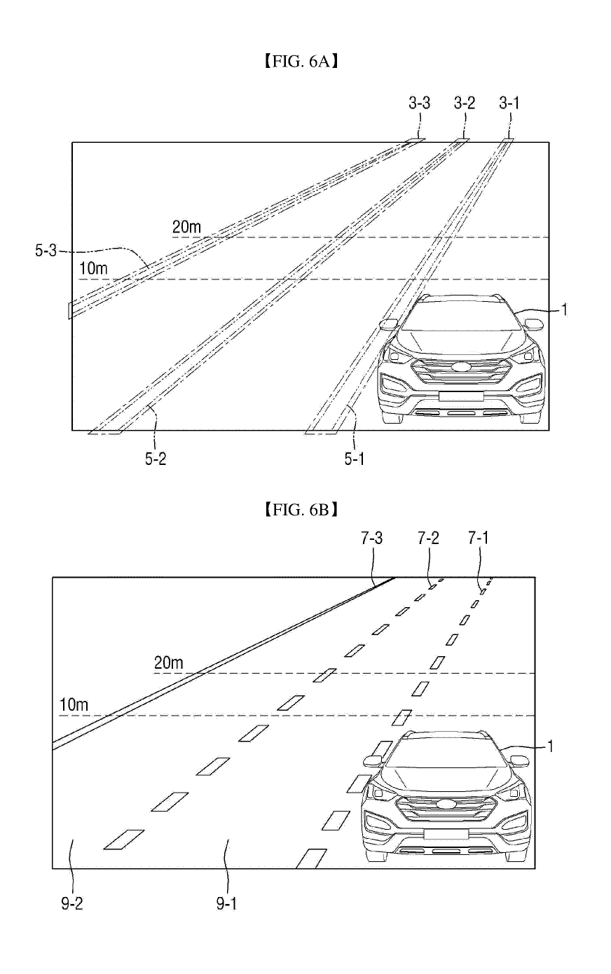

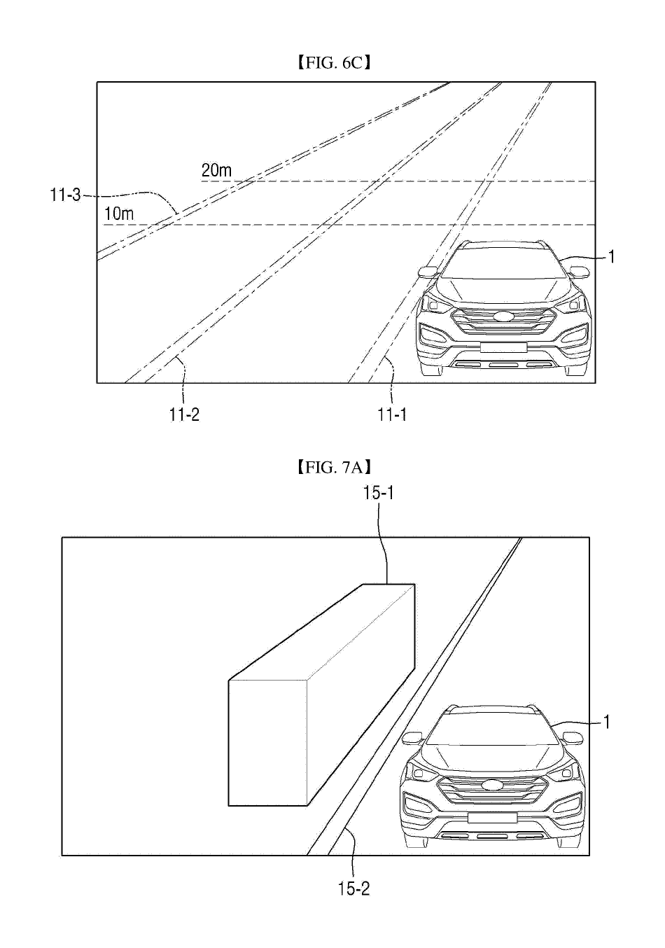

FIGS. 6A through 6C are diagrams for explaining lane line detection and determination in a lane change support method according to an embodiment. The lane line detection and determination will now be described with reference to FIGS. 6A through 6C.

FIG. 6A is a diagram for explaining a process of detecting lane lines using a lane line region candidate group. Based on a driving vehicle 1, a lane line region setting unit sets virtual lane lines by using a lane line region candidate group set according to the standard road lane line width. In the current embodiment, the lane line region candidate group is set to a first lane line region candidate 3-1, a second lane line region candidate 3-2, and a third lane line region candidate 3-3. A first virtual lane line 5-1, a second virtual lane line 5-2, and a third virtual lane line 5-3 are set in the lane line region candidate group. The lane line region candidate group and the virtual lane lines 5-1 through 5-3 can be changed to straight lines or curved lines according to road conditions. When the lane line region candidate group is used, the time required to detect lane lines can be reduced. It is determined whether the set virtual lines 5-1 through 5-3 match actual lane lines. The virtual lines 5-1 through 5-3 can also be set without using the lane line region candidate group.

The vehicle 1 includes a first image sensor provided on its side and a second image sensor provided on its rear. The first image sensor obtains an image of an area on the side of the vehicle 1, and the second image sensor obtains an image of an area behind the vehicle 1. In the current embodiment, the obtained image of the area on the side of the vehicle 1 and the obtained image of the area behind the vehicle 1 may be merged as shown in FIG. 6A in order to detect not only another vehicle close to the vehicle 1 but also another vehicle travelling in a different lane from the vehicle 1 and far behind the vehicle 1.

FIG. 6B illustrates a case where the set virtual lane lines 5-1 through 5-3 are determined as actual lane lines. In FIG. 6B, a first lane line 7-1, a second lane line 7-2, and a third lane line 7-3 are determined as actual lane lines. When the actual lane lines are determined, a lane between the actual lane lines is determined as a lane in which vehicles other than a vehicle 1 can travel. Referring to FIG. 6B, a lane between the first lane line 7-1 and the second lane line 7-2 is determined as a first lane 9-1. A lane between the second lane line 7-2 and the third lane line 7-3 is determined as a second lane 9-2. A lane line judgment unit determines whether the determined actual lane lines are dotted lines or solid lines. In FIG. 6B, the first lane line 7-1 and the second lane line 7-2 are determined to be dotted lines, and the third lane line 7-3 is determined to be a solid line. A solid line corresponds to a lane line where a lane change is prohibited, and a dotted line corresponds to a lane line where a lane change is possible. The solid line may correspond to a centerline, a lane line in a tunnel, a lane line in an overpass, or the like.

After the lane lines are determined, information about in which lane the vehicle 1 is currently travelling may be provided in the lane change support method according to the current embodiment.

A lane information providing method according to an embodiment may include judging whether the detected lane lines are dotted lines or solid lines and providing current lane information of the vehicle 1 based on solid lane lines among the judged lane lines. For example, the number of dotted lane lines between a current lane of the vehicle 1 and each of the solid lane lines determined on both sides of the vehicle 1 may be identified to inform the driver of the vehicle 1 about the current lane. In an embodiment, the current lane of the vehicle 1 may be identified only by counting the number of dotted lane lines detected in a left image. For example, if the number of dotted lane lines located between the centerline (solid line) and the current lane of the vehicle 1 is two in the left image, it may be determined that the vehicle 1 is currently traveling in a third lane.

However, there may be cases where it is difficult to accurately determine in which lane the vehicle 1 is currently travelling based on only the number of dotted lane lines. For example, when a large vehicle such as a trailer truck is travelling on a side of or behind the vehicle 1 or when the vehicle 1 is travelling on a wide road whose lanes are not all captured in a side image, it may be difficult to accurately determine in which lane the vehicle 1 is currently travelling. Thus, a lane information providing method according to an embodiment may include receiving information about the number of lanes on a road on which the vehicle 1 is currently travelling from a navigation device provided in the vehicle 1 and determining in which lane the vehicle 1 is currently travelling by additionally using the information about the number of lanes. For example, when the navigation device provides information indicating that the current road is a one-way 8-lane road, the dotted first lane line 7-1, the dotted second lane line 7-2 and the solid third lane line 7-3 may be determined on a right side of the vehicle 1 in the obtained image. Therefore, the driver of the vehicle 1 may be informed that the vehicle 1 is currently travelling on a sixth lane of the road.

As described above, it is possible to more accurately determine in which lane the vehicle 1 is currently travelling by using the number of dotted lane lines and information about the number of lanes on the current road provided by the navigation device.

FIG. 6C illustrates a case in which default lane lines are created when there is no actual lane line around a vehicle 1. When there is no lane line on a road or when it is difficult to detect lane lines because the lane lines are blurry, default lane lines are created to generate virtual lane lines, set a vehicle detection region based on the virtual lane lines, and analyze the possibility of collision with another vehicle. Referring to FIG. 6C, a first default lane line 11-1 closest to a vehicle 1, a second default lane line 11-2 next to the first default lane line 11-1, and a third default lane line 11-3 next to the second default lane line 11-2 are created.

When the default lane lines are created, the detection unit analyzes the possibility of collision with another vehicle in a lane created based on the default lane lines. The lane created based on the default lane lines is considered as a lane marked by actual lane lines. Referring to FIG. 6C, a first lane 9-1 is created between the first default lane line 11-1 and the second default lane line 11-2, and a second lane 9-1 is created between the second default lane line 11-2 and the third default lane line 11-3. Vehicle detection regions are set based on the created first and second lanes 9-1 and 9-2, and lane-changing vehicle detection regions are set based on the created first and second default lane lines 11-1 and 11-2. The vehicle detection regions and the lane-changing vehicle detection regions will be described in detail later.

Although only one side of the vehicle 1 is illustrated in FIGS. 6A through 6C in order to help understand the embodiment, all lane lines on the left and right sides of the vehicle 1 can be detected and determined.

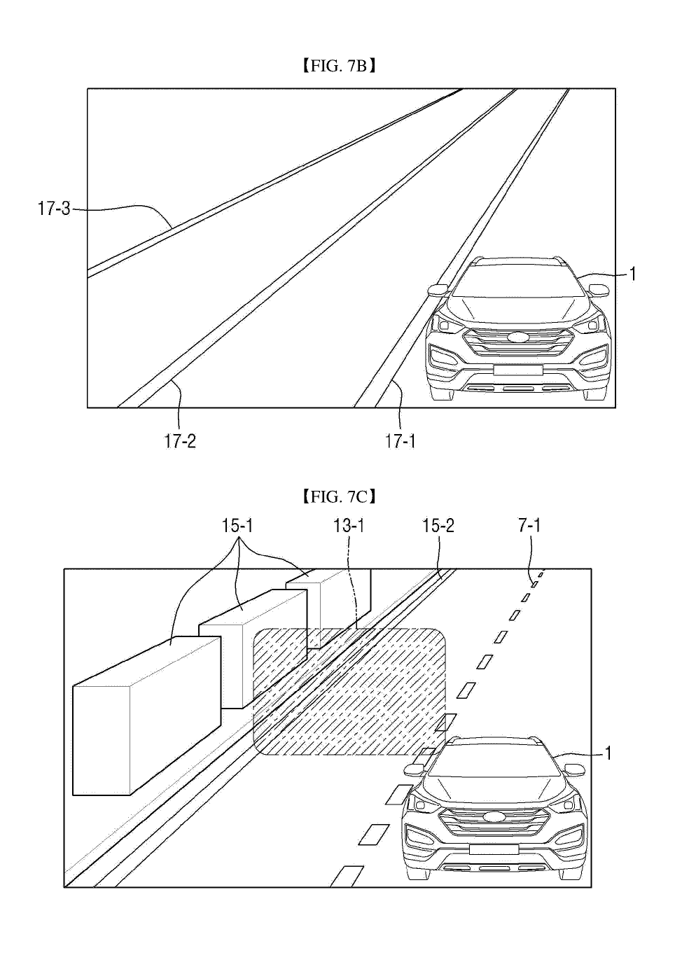

FIGS. 7A through 7C are diagrams for explaining examples of a lane change prohibited region in a lane change support method according to an embodiment. Examples of the lane change prohibited region will now be described with reference to FIGS. 7A through 7C.

In FIG. 7A, a vehicle 1, an obstacle 15-1, and a prohibited lane line 15-2 are illustrated. The prohibited lane line 15-2 corresponds to a prohibited lane line determined by the lane line judgment unit. The collision possibility analysis unit determines whether an object around the vehicle 1 is a movable object or a fixed object. The obstacle 15-1 illustrated in FIG. 7A corresponds to a fixed object. Since the lane line illustrated in FIG. 7A corresponds to the prohibited lane line 15-2, the warning notification unit warns against changing lanes. In addition to determining the prohibited lane line 15-1 and warning against changing lanes, it is possible to judge that there is a possibility of collision with the obstacle 15-1 using the collision possibility analysis unit and warn against changing lanes using the warning notification unit. If the prohibited lane 15-2 is not detected, the collision possibility analysis unit judges that there is a possibility of collision with the obstacle 15-1, and the warning notification unit warns against changing lanes.

FIG. 7B illustrates a case where all detected lane lines correspond to prohibited lane lines. A first prohibited lane 17-1, a second prohibited lane line 17-2 and a third prohibited lane line 17-3 are detected based on a vehicle 1. This may correspond to a case where the vehicle 1 is passing through a tunnel or an overpass. If all of the detected lane lines correspond to prohibited lane lines, the warning notification unit warns against changing lanes.

FIG. 7C illustrates a case where a vehicle 1 is travelling one lane away from obstacles 15-1 and a prohibited lane line 15-2. Since a first lane line 7-1 is a dotted lane line, it is possible to change lanes. Therefore, the warning notification unit informs that a lane change is possible. A vehicle detection region 13-1 is set between the first lane line 7-1 and the prohibited lane line 15-2. Vehicle detection and collision possibility analysis based on the vehicle detection region will be described later.

Although only one side of the vehicle 1 is illustrated in FIGS. 7A through 7C in order to help understand the embodiment, the embodiment is not limited to only one side of the vehicle 1.

FIGS. 8A through 8E are diagrams for explaining vehicle detection region setting and a lane-changing vehicle detection region in a lane change support method according to an embodiment. The vehicle detection region setting and the lane-changing vehicle detection region will now be described with reference to FIGS. 8A through 8E.

FIG. 8A illustrates a case where a vehicle detection region setting unit sets a vehicle detection region. A process of setting the vehicle detection region will now be described in detail. The vehicle detection region corresponds to an ROI for detecting a vehicle. Since the vehicle detection region is set in order to detect a moving object, it may be set at various distances from a vehicle.

Referring to FIG. 8A, a first vehicle detection region 13-1 and a second vehicle detection region 13-2 are set. When an image obtained by the image sensor unit is provided to the detection unit, a lane line detection unit detects and determines lane lines. In FIG. 8A, a first lane line 7-1, a second lane line 7-2 and a third lane line 7-3 are detected and determined based on a vehicle 1. The first vehicle detection region 13-1 is set in order to detect an object passing between the first lane line 7-1 and the second lane line 7-2. The second vehicle detection region 13-2 is set in order to detect an object passing between the second lane line 7-2 and the third lane line 7-3. When an object moving in a vehicle detection region is detected, the collision possibility analysis unit judges the possibility of collision by analyzing a change in the speed or size of the moving object. The collision possibility analysis unit judges the possibility of collision, and the warning notification unit informs the judged possibility of collision.

FIG. 8B illustrates a case where the vehicle detection region setting unit sets a plurality of vehicle detection regions in each lane. The vehicle detection region setting unit may simultaneously detect a plurality of objects in a lane by setting a plurality of vehicle detection regions in the lane.

Referring to FIG. 8B, a first vehicle detection region 13-1, a second vehicle detection region 13-2, a third vehicle detection region 13-3, a fourth vehicle detection region 13-4, and a fifth vehicle detection region 13-5 are set in a first lane 9-1. In addition, a sixth vehicle detection region 13-6, a seventh vehicle detection region 13-7, an eighth vehicle detection region 13-8, and a ninth vehicle detection region 13-9 are set in a second lane 9-2. The number of vehicle detection regions in each lane is not limited to that in the current embodiment, but can be adjusted according to the number of vehicles in an image obtained by the image sensor unit or the traffic volume on a driving road. For example, when there is only one vehicle other than a vehicle 1, one vehicle detection region may be set without setting a plurality of vehicle detection regions.

An image processing process in a case where a plurality of vehicle detection regions are set in the first lane 9-1 will now be described with reference to FIG. 8B again. The detection unit may set a plurality of vehicle detection regions along a driving direction in order to detect vehicles travelling in the first lane 9-1. However, the larger the number of vehicle detection regions, the less efficient in terms of image processing speed. Therefore, once the detection unit detects a vehicle in any one of the vehicle detection regions, it may no longer perform the process of detecting vehicles in the remaining vehicle detection regions.

In addition, the number of vehicle detection regions may be different in the first lane 9-1 and the second lane 9-2. Since the vehicle 1 is more likely to collide with a vehicle in the first lane 9-1 than in the first lane 9-2, the detection unit may set more vehicle detection regions in the first lane 9-1 than in the second lane 9-2 in order for efficient image processing.

FIG. 8C illustrates a case where the vehicle detection region setting unit sets a lane-changing vehicle detection region on a lane line. The lane-changing vehicle detection region corresponds to an ROI for detecting a vehicle. In order to detect a vehicle that changes lanes, a lane-changing vehicle detection region may be set as a plane parallel to a lane line as illustrated in FIG. 8C, in addition to a vehicle detection region set as illustrated in FIGS. 8A and 8B.

Referring to FIG. 8C, a first lane-changing vehicle detection region 14-1 is set parallel to a first lane line 7-1, and a second lane-changing vehicle detection region 14-2 is set parallel to a second lane line 7-2.

The first lane-changing vehicle detection region 14-1 detects a vehicle moving through the first lane line 7-1. For example, when a vehicle behind the vehicle 1 attempts to overtake the vehicle 1 by moving to a first lane 9-1 and then moving from the first lane 9-1 to the same lane as the vehicle 1, the first lane-changing vehicle detection region 14-1 can detect the vehicle. In addition, the first lane-changing vehicle detection region 14-1 can detect a vehicle suspected of drowsy driving or drunk driving by determining whether a vehicle behind the vehicle 1 invades the first lane line 7-1 and provide danger information to the driver of the vehicle 1.

The second lane-changing vehicle detection region 14-2 detects a vehicle moving through the second lane line 7-2. For example, the second lane-changing vehicle detection region 14-2 can detect a vehicle moving from a second lane 9-2 to the first lane 9-1. In addition, the second lane-changing vehicle detection region 14-2 can detect a vehicle suspected of drowsy driving or drunk driving by determining whether a vehicle invades the first lane line 7-1 or the second lane line 7-2 and provide danger information to the driver of the vehicle 1.

FIG. 8D illustrates a case where both a vehicle detection region and a lane-changing vehicle detection region are set. Referring to FIG. 8D, a first lane-changing vehicle detection region 14-1 is set parallel to a first lane line 7-1, and a first vehicle detection region 13-1 and a second vehicle detection region 13-2 are set in a first lane 9-1. In addition, a second lane-changing vehicle detection region 14-2 is set parallel to a second lane line 7-2, and a third vehicle detection region 13-3 and a fourth vehicle detection region 13-4 are set in a second lane 9-2. A lane-changing vehicle detection region is set on a lane line to be parallel to the lane line so as to detect a vehicle passing through the lane-changing vehicle detection region. The lane-changing vehicle detection region may analyze the possibility of collision with a vehicle that changes lanes by sensing the size and speed of the vehicle.

FIG. 8E illustrates a case where both a vehicle detection region and a lane boundary region are set simultaneously. A lane boundary region 15 corresponds to an ROI for detecting a vehicle. Referring to FIG. 8E, a first vehicle detection region 13-1, a second vehicle detection region 13-2, and a third vehicle detection region 13-3 are set in a first lane. The lane boundary region 15 includes a second lane line 7-2 and is set side by side with the first lane. The lane boundary region 15 is a region for detecting a vehicle that changes lanes.

A vehicle suspected of drowsy driving or drunk driving can be detected by determining whether a vehicle invades a first lane line 7-1 or the second lane line 7-2, and then danger information can be provided to the driver of the vehicle 1.

The number and area of vehicle detection regions and the area and number of lane boundary regions may influence the amount of computation required in the image processing of the detection unit. Therefore, it is necessary to minimize the number and area of vehicle detection regions and lane boundary regions.

A vehicle detection region and a lane-changing vehicle detection region may analyze the possibility of collision with a vehicle that changes lanes by sensing the size and speed of the vehicle. On the other hand, the lane boundary region 15 may analyze the possibility of collision by detecting a vehicle passing through the lane boundary region 15 without analyzing the size and speed of the vehicle. Therefore, it is possible to more accurately and quickly analyze the possibility of collision by detecting a vehicle that changes lanes using the lane boundary region 15 than by using the lane-changing vehicle detection region.

The number of vehicle detection regions, the number of lane-changing vehicle detection regions, and the number of lane boundary regions are not limited to those in the current embodiment, but can be adjusted according to the number of vehicles in an image obtained by the image sensor unit or the traffic volume on a driving road. If there are not many vehicles around the vehicle 1, the number of vehicle detection regions may be minimized in order for efficient image processing.

The number and area of ROIs may be adjusted for efficient image processing. Since the number and size of ROIs affect the image processing speed, they may be adjusted according to the traffic volume in a driving lane.

Although only one side of the vehicle 1 is illustrated in FIGS. 8A through 8E in order to help understand the embodiments, the embodiments are not limited to only one side of the vehicle 1.

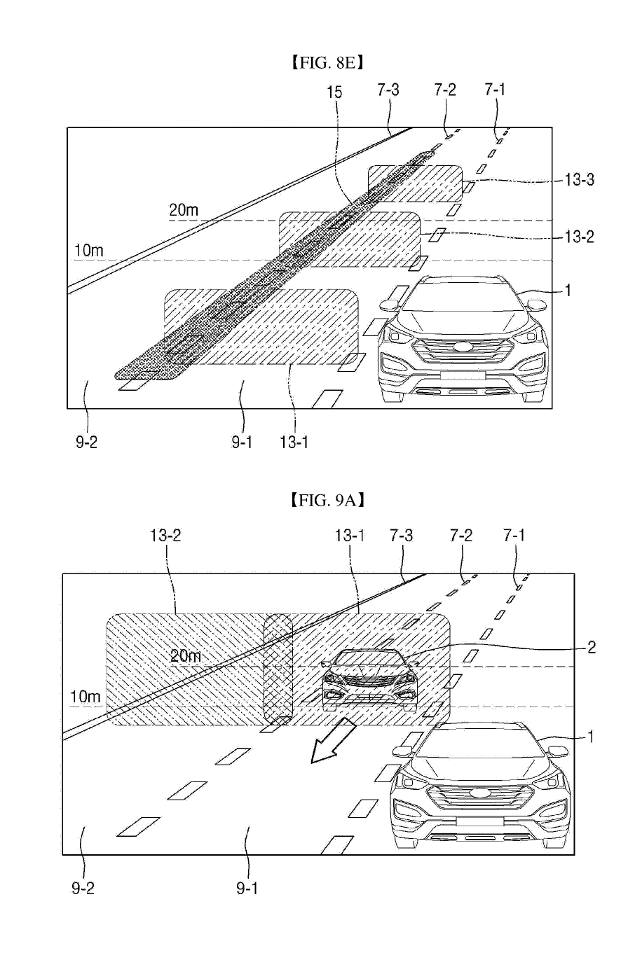

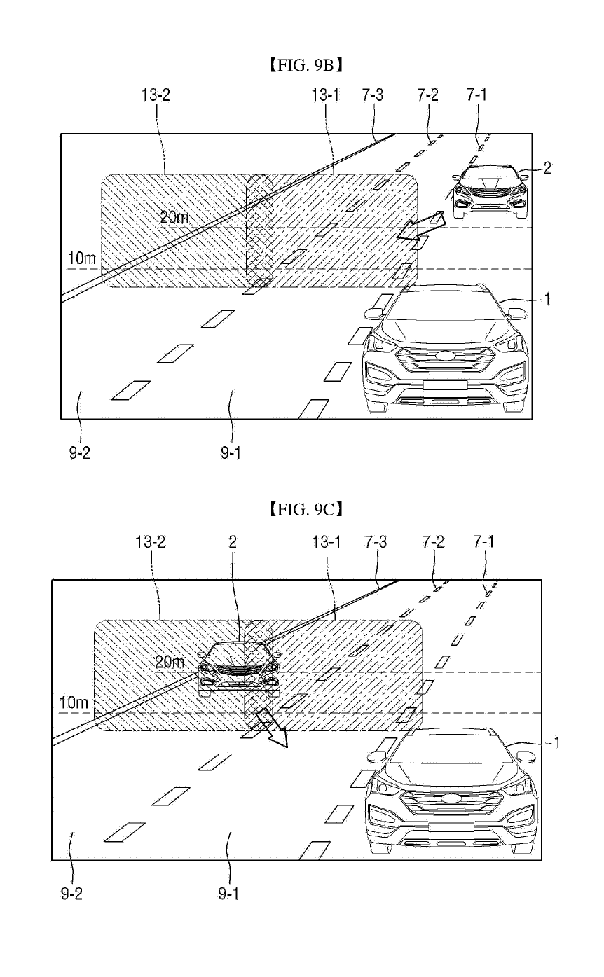

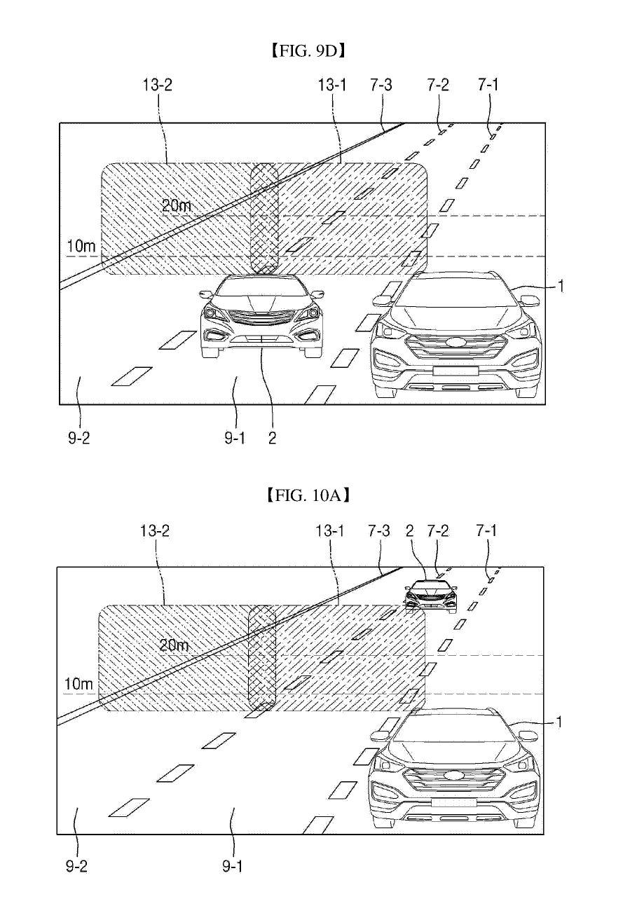

FIGS. 9A through 9D are diagrams for explaining collision possibility determination in a lane change support method according to an embodiment. The collision possibility determination will now be described with reference to FIGS. 9A through 9D.

FIG. 9A is a diagram for explaining the judgment of the possibility of collision between a first vehicle 1 and a second vehicle 2 moving in a first lane 9-1 between a first lane line 7-1 and a second lane line 7-2. A first vehicle detection region 13-1 is set in order to detect the second vehicle 2 moving in the first lane 9-1. A second vehicle detection region 13-2 is set in order to detect a vehicle moving in a second lane 9-2. Referring to FIG. 9A, the second vehicle 2 is moving in the first lane 9-1. A vehicle detection unit detects the second vehicle 2 moving in the first lane 9-1 through the first vehicle detection region 13-1. The collision possibility analysis unit analyzes a change in the speed or size of the detected second vehicle 2 to analyze the possibility of collision between the first vehicle 1 and the second vehicle 2. If the speed of the second vehicle 2 is lower than that of the first vehicle 1, there is no possibility of collision. Therefore, the warning notification unit informs that a lane change is possible. If the speed of the second vehicle 2 is higher than that of the first vehicle 1, there is a possibility of collision. Therefore, the warning notification unit warns against changing lanes.

FIG. 9B is a diagram for explaining the judgment of the possibility of collision between a first vehicle 1 and a second vehicle 2 when the first vehicle 1 and the second vehicle 2 are traveling in the same lane. A first vehicle detection region 13-1 is set in order to detect the second vehicle 2 which is to move in a first lane 9-1. A second vehicle detection region 13-2 is set in order to detect a vehicle which is to move in a second lane 9-2.

Referring to FIG. 9B, the second vehicle 2 is moving in the same lane as the first vehicle 1. When the collision possibility analysis unit determines that the second vehicle 2 does not intend to change lanes and that there is no possibility of collision between the first vehicle 1 and the second vehicle 2, the warning notification unit informs that a lane change is possible.

When it is determined that, although the second vehicle 2 does not intend to change lanes, there is a possibility of collision because the speed of the second vehicle 2 is higher than that of the first vehicle 1, the warning notification unit warns of a possible collision.

A case where the first vehicle 1 and the second vehicle 2 intend to change to the first lane 9-1 at the same time will now be described. In a conventional lane change support apparatus and method, the possibility of collision can be judged only when a vehicle is running side by side with another vehicle or when there is a vehicle in a blind spot.

In the lane change support method according to the current embodiment, however, the possibility of collision can also be judged when the first vehicle 1 and the second vehicle 2 attempt to change lanes at the same time by using a first image sensor provided on the side of the first vehicle 1 and a second image sensor provided on the rear of the first vehicle 1. The second image sensor provided on the rear of the first vehicle 1 obtains an image of the second vehicle 2 and analyzes the obtained image. In the obtained image, the collision possibility analysis unit analyzes the speed and position of the second vehicle 2. In addition, the collision possibility analysis unit analyzes whether a vehicle is detected in the first vehicle detection region 13-1 in the obtained image. If a vehicle is detected in the first vehicle detection region 13-1, there is a possibility of collision when the first vehicle 1 attempts to change to the first lane 9-1. Therefore, the warning notification unit warns of a possible collision.

FIG. 9C is a diagram for explaining the judgment of the possibility of collision when a first vehicle 1 and a second vehicle 2 attempt to change to the same first lane 9-1. In a conventional lane change support apparatus and method, the possibility of collision can be judged only when a vehicle is running side by side with another vehicle or when there is a vehicle in a blind spot. In the lane change support method according to the current embodiment, however, the possibility of collision can also be analyzed and judged even when the second vehicle 2 is travelling in a lane not adjacent to the first vehicle 1. The possibility of collision when the second vehicle 2 is traveling in a second lane 9-2 will now be described with reference to FIG. 9D.

When the first vehicle 1 does not intend to change lanes and the second vehicle 2 traveling in the second lane 9-2 does not intend to change lanes, the collision possibility analysis unit fails to sense a change in the movement of the second vehicle 2 in a second vehicle detection region 13-2. In this case, there is no possibility of collision between the first vehicle 1 and the second vehicle 2. However, when both the first vehicle 1 and the second vehicle 2 simultaneously attempt to change to the first lane 9-1, there is a possibility of collision. The first vehicle detection region 13-1 is set in order to detect the second vehicle 2 moving from the second lane 9-2 to the first lane 9-1. A second vehicle detection region 13-2 is set in order to detect a vehicle moving in the second lane 9-2.

Referring to FIG. 9C, the second vehicle 2 is moving in the second lane 9-2. The vehicle detection unit detects the second vehicle 2 moving in the second lane 9-2 through the second vehicle detection region 13-2. For example, when the first vehicle 1 attempts to change to the first lane 9-1 using a turn signal lamp, the collision possibility analysis unit analyzes the speed and position of the second vehicle 2 detected in the second vehicle detection region 13-2. If the second vehicle 2 also attempts to change to the first lane 9-1, it can collide with the first vehicle 1. Therefore, the collision possibility analysis unit determines that there is a possibility of collision, and the warning notification unit warns against changing lanes.

FIG. 9D is a diagram for explaining the possibility of collision when a first vehicle 1 and a second vehicle 2 are located close to each other. In FIG. 9D, the second vehicle 2 is running side by side with the first vehicle 1. In this case, if the first vehicle 1 changes lanes, it may collide with the second vehicle 2 regardless of the speed of the second vehicle 2. Therefore, the collision possibility analysis unit determines that there is a possibility of collision, and the warning notification unit warns against changing lanes. The collision possibility analysis unit detects the second vehicle 2 in a vehicle detection region 13-1 and analyzes a change in the speed and size of the second vehicle 2. If the second vehicle 2 drives ahead of the first vehicle 1, the warning notification unit informs that a lane change is possible. If the second vehicle 2 is side by side with the first vehicle 1 or travelling behind the first vehicle 1 at high speed, the collision possibility analysis unit determines that there is a possibility of collision, and the warning notification unit warns against changing lanes.

Although only one side of the first vehicle 1 is illustrated in FIGS. 9A through 9D in order to help understand the embodiment, the embodiment is not limited to only one side of the first vehicle 1.

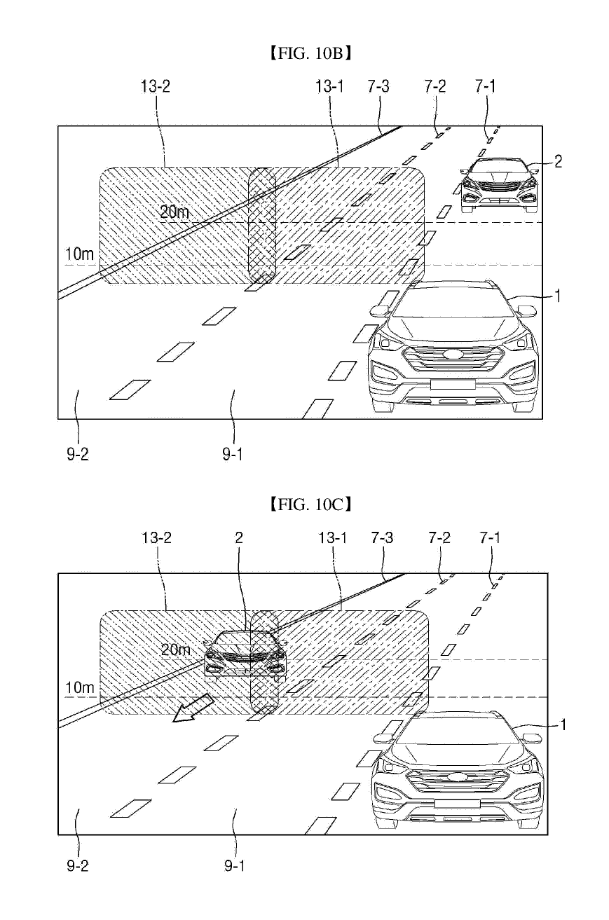

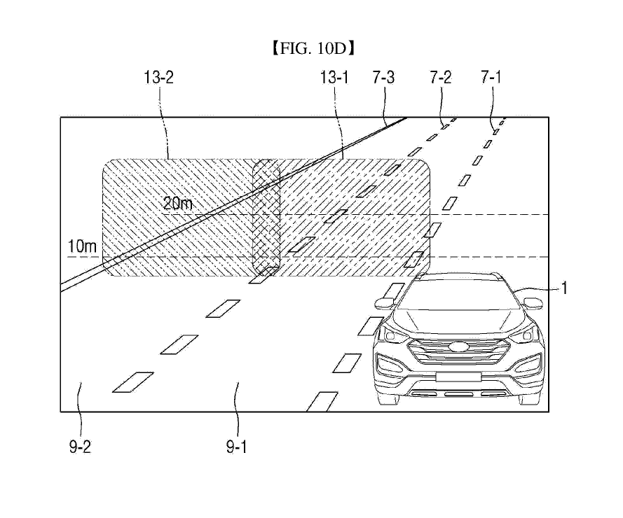

FIGS. 10A through 10D are diagrams for explaining examples of collision avoidance determination in a lane change support method according to an embodiment. The collision avoidance determination will now be described with reference to FIGS. 10A through 10D.

FIG. 10A illustrates a case where a second vehicle 2 is detected at about 20 meters behind from a first vehicle 1. The lane line detection unit detects and determines lane lines in an image obtained by an image sensor. The vehicle detection region setting unit sets vehicle detection regions 13-1 and 13-2 based on the determined lane lines. The second vehicle 2 is detected in the set vehicle detection region 13-1. A change in the relative speed or size of the detected second vehicle 2 may be sensed to analyze the possibility of collision. In addition, the distance from the first vehicle 1 may be identified to analyze the possibility of collision. If the distance between the first vehicle 1 and the second vehicle 2 is 20 meters or more, the possibility of collision is low. Therefore, the collision possibility analysis unit determines that the possibility of collision is low, and the warning notification unit informs that a lane change is possible. If the distance between the first vehicle 1 and the second vehicle 2 is 10 meters or less, there is a possibility of collision. Therefore, the collision possibility analysis unit determines that there is a possibility of collision, and the warning notification unit warns against changing lanes.

FIG. 10B illustrates a case where a second vehicle 2 is detected behind a first vehicle 1 but does not enter a first lane 9-1. The lane line detection unit detects and determines lane lines in an image obtained by an image sensor. The vehicle detection region setting unit sets first and second vehicle detection regions 13-1 and 13-2 based on the determined lane lines. In FIG. 10B, the second vehicle 2 is detected not in the first vehicle detection region 13-1 and the second vehicle detection region 13-2, but behind the first vehicle 1. Since the second vehicle 2 does not enter the first lane 9-1, the collision possibility analysis unit determines that the possibility of collision is low, and the warning notification unit informs that a lane change is possible. However, if the relative speed of the second vehicle 2 is higher than that of the first vehicle 1, there is a possibility of collision. In this case, the collision possibility analysis unit determines that there is a possibility of collision, and the warning notification unit warns of a possible collision.

FIG. 10C illustrates a case where a second vehicle 2 is detected in a second lane 9-2 but does not enter a first lane 9-1. The lane line detection unit detects and determines lane lines in an image obtained by an image sensor. The vehicle detection region setting unit sets a first vehicle detection region 13-1 and a second vehicle detection region 13-2 based on the determined lane lines. The second vehicle 2 is detected in the set second vehicle detection region 13-2. A change in the relative speed or size of the detected second vehicle 2 may be sensed to analyze the possibility of collision. The second vehicle 2 traveling in the second lane 9-2 is detected in the second vehicle detection region 13-2. Since the second vehicle 2 is not likely to enter the first lane 9-1, the collision possibility analysis unit determines that there is no possibility of collision, and the warning notification unit informs that a lane change is possible.

FIG. 10D illustrates a case where there is no vehicle in a first lane 9-1 and a second lane 9-2 behind a first vehicle 1. The lane line detection unit detects and determines lane lines in an image obtained by an image sensor. The vehicle detection region setting unit sets first and second vehicle detection regions 13-1 and 13-2 based on the determined lane lines. Since no vehicle is detected in the first vehicle detection region 13-1 and the second vehicle detection region 13-2, the collision possibility analysis unit determines that there is no possibility of collision, and the alarm notification unit informs that a lane change is possible.

Although only one side of the first vehicle 1 is illustrated in FIGS. 10A through 10D in order to help understand the embodiment, the embodiment is not limited to only one side of the first vehicle 1.

The concepts of the invention described above with reference to FIGS. 1 to 10D can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A lane change support method comprising:
detecting a plurality of lane lines by analyzing an image obtained by a first image sensor disposed at a side of a vehicle;
setting a vehicle detection region for detecting a moving object in the image obtained by the first image sensor based on the detected plurality of lane lines;
detecting the moving object in the set vehicle detection region and judging a possibility of collision between the vehicle and the detected moving object; and
providing lane change information indicating whether it is dangerous for the vehicle to change lanes based on the result of judging the possibility of collision.

2. The method of claim 1, wherein the setting of the vehicle detection region comprises setting a plurality of first vehicle detection regions in a first lane, which is formed by two lane lines, from among the plurality of lane lines, such that the plurality of first vehicle detection regions are arranged along a driving direction of the first lane, and
wherein the first lane is adjacent to a lane the vehicle is in.

3. The method of claim 2, wherein the judging of the possibility of collision comprises:
performing a process of detecting the moving object in a first vehicle detection region, from among plurality of first vehicle detection regions, the first vehicle detection region being closest to the vehicle; and
not performing the process of detecting the moving object in the remaining first vehicle detection regions if the object is detected in the first vehicle detection region closest to the vehicle.

4. The method of claim 2, wherein the detecting of the plurality of lane lines comprises:
detecting a first lane line, from among the plurality of lane lines, the first lane line being the closest to the side of the vehicle in a horizontal direction; and
detecting a second lane line, from among the plurality of lane lines, the second lane line being the next closest to the side of the vehicle in the horizontal direction,
wherein the first lane is a lane between the first lane line and the second lane line,
wherein the setting of the plurality of first vehicle detection regions in the first lane comprises setting a lane boundary region comprising the second lane line, and
wherein the first vehicle detection regions are arranged along the driving direction of the first lane.

5. The method of claim 2, wherein the detecting of the lane lines comprises:
detecting a first lane line, from among the plurality of lane lines, the first lane line being the closest to the side of the vehicle in a horizontal direction; and
detecting a second lane line, from among the plurality of lane lines, the second lane line being the next closest to the side of the vehicle in the horizontal direction,
wherein the first lane is a lane between the first lane line and the second lane line,
wherein the first vehicle detection regions are arranged along the driving direction of the first lane,
wherein the setting of the plurality of first vehicle detection regions further comprises setting a plurality of second vehicle detection regions in a second lane, which is adjacent to the first lane, in the horizontal direction, with the second lane line interposed between the first lane and the second lane, such that the second vehicle detection regions are arranged along a driving direction of the second lane adjacent to the first lane, and
wherein an amount of the first vehicle detection regions is larger than an amount of the second vehicle detection regions.

6. The method of claim 1, wherein the plurality of lane lines is a first plurality of lane lines and the vehicle detection region is a first vehicle detection region, the method further comprising:
detecting a second plurality of lane lines by analyzing an image obtained by a second image sensor disposed at a rear of the vehicle; and
setting a second vehicle detection region for detecting an object moving behind the vehicle in the image obtained by the second image sensor based on the detected second plurality of lane lines.

7. The method of claim 1, wherein the detecting of the plurality of lane lines comprises detecting lane lines using a lane line region candidate group set according to a standard road lane width.

8. The method of claim 1, wherein the detecting of the plurality of lane lines comprises determining whether the detected plurality of lane lines are dotted lines or solid lines, and the providing of the lane change information based on the result of judging the possibility of collision comprises warning against changing lanes if the detected lane lines are solid lines.

9. The method of claim 1, wherein the detecting of the plurality of lane lines comprises determining whether the detected plurality of lane lines are dotted lines or solid lines, identifying a solid lane line and counting a number of dotted lane lines between the identified solid lane line and a lane the vehicle is in and further comprising providing current lane information based on the counted number of the dotted lane lines.

10. The method of claim 9, wherein the providing of the current lane information based on the counted number of the dotted lane lines comprises providing the current lane information based on information about the number of lanes on a current road received from a navigation device in the vehicle and the counted number of the dotted lane lines.

11. The method of claim 8, wherein the warning against changing lanes if the detected lane lines are solid lines comprises warning against changing lanes if a lane line closest to the side of the vehicle is a solid line.

12. The method of claim 1, wherein the detecting of the plurality of lane lines by analyzing the image obtained by the first image sensor disposed at the side of the vehicle comprises, if no lane line is detected in the obtained image, creating virtual lane lines set according to a standard road lane line width in the obtained image.

13. The method of claim 1, wherein the vehicle detection region comprises a first vehicle detection region and a second vehicle detection region, wherein the first vehicle detection region is formed in a first lane which is adjacent to a lane the vehicle is in, in a horizontal direction, and the second vehicle detection region is formed in a second lane which is adjacent to the first lane, in the horizontal direction.

14. The method of claim 13, wherein the detecting of the moving object in the set vehicle detection region and the judging of the possibility of collision between the vehicle and the detected moving object comprises judging the possibility of collision between the vehicle moving to the first vehicle detection region and the detected moving object when the detected moving object moves from the second vehicle detection region to the first vehicle detection region.

15. The method of claim 1, wherein the detecting of the moving object in the set vehicle detection region and the judging of the possibility of collision between the vehicle and the detected moving object comprises judging the possibility of collision by analyzing a change in a size of the detected object.

16. The method of claim 1, wherein the detecting of the moving object in the set vehicle detection region and the judging of the possibility of collision between the vehicle and the detected moving object comprises judging the possibility of collision by extracting a relative speed vector of the detected moving object with respect to the vehicle in the obtained image.

17. A lane change support method comprising:
detecting a plurality of lane lines by analyzing an image obtained by a first image sensor disposed at a side of a vehicle;
setting a vehicle detection region for detecting a moving object in the image obtained by the first image sensor based on the detected plurality of lane lines;
repetitively monitoring vehicle detection region for the moving object;
in response to detecting the moving object, repetitively judging a possibility of collision between the vehicle and the detected moving object;
automatically providing an alert indicating it is dangerous for the vehicle to change lanes, based on a first result of repetitively judging the possibility of collision; and
automatically stopping the alert, based on a second result of repetitively judging the possibility of collision.
